(19) United States
(12) Patent Application Publication
(10) Pub. No.: US 2004/0193723 A1
(43) Pub. Date: Sep. 30, 2004

(54) Method and system for streaming delivery and program and program recording medium thereof

(75) Inventor: Koji Kabatani, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/775,159

(22) Filed: Feb. 11, 2004

(30) Foreign Application Priority Data
Mar. 26, 2003 (JP) 2003-084141

(51) Int. Cl. G06F 15/16

(52) U.S. Cl. 709/231

(57) ABSTRACT

In a streaming delivery method, a streaming server collects text data, which is written from a user terminal, relating to a moving image content being streamed, superimposes the collected text data on the moving image content being streamed, and delivers the moving image content on which a plurality of the text data is superimposed to the user terminal.

### BACKGROUND OF THE INVENTION

1. Field of the Invention

This invention relates to method and system for streaming delivery and program and program recording medium thereof, and more particularly to method and system for streaming delivery and program and program recording medium thereof for superimposing text data associated with a moving image content on that moving image content and delivering the moving image content with the text data.

2. Description of the Related Art

Many contents such as sport games, lectures, and concerts are live broadcast on television. And, in recent years, contents such as sport games are deliver to users over the Web, using streaming technologies. Furthermore, on the Web, users can chat with one another in real time on a Web site such as a bulletin board devoted to a particular content while the content is being delivered over the Web or broadcast on television. Such chats allow users who cannot go to the hall or stadium to feel togetherness with the audience in the hall or stadium, and the users get excited.

It is known that when a content (for example a music content) of interest to users is streamed, textual or voice information is inserted in it (Japanese Patent Laid-Open No. 2003-016093, for example). Further, it is also known that music data is delivered along with text (for example lyrics) or image data selected by a user to the user's terminal, and the music data and text or image data are synchronized with each other according to synchronization information and reproduced as a streaming content on the user's terminal (Japanese Patent Laid-Open No. 2002-073049, for example).

The content delivered or broadcast is displayed on a display device and the bulletin board on which chats are carried out is displayed on another, separate display device. This is very inconvenient for the user who wants to chat while watching the content. For example, the user cannot watch TV while the user is reading chats on the bulletin board on a personal computer. When the personal computer and the television are placed side by side, the user can look at both of the content and bulletin board at the same time. However, the user has to do more than one thing at a time and therefore cannot concentrate on watching the television content.

Moreover, text data posted by users to a bulletin board is not streamed along with a content being distributed or broadcast, nor is superimposed on the content. Therefore, the position and time at which the text data is displayed cannot be changed according to the content of the text data.

### SUMMARY OF THE INVENTION

An object of the present invention is to provide a streaming delivery method for superimposing text data associated with a moving image content to be streamed on the moving image content and delivering the moving image content with the text data.

Another object of the present invention is to provide a streaming delivery system for superimposing text data associated with a moving image content to be streamed on the moving image content and delivering the moving image content with the text data.

Another object of the present invention is to provide a streaming server for superimposing text data associated with a moving image content to be streamed on the moving image content and delivering the moving image content with the text data.

Still another object of the present invention is to provide a streaming delivery program for superimposing text data associated with a moving image content to be streamed on the moving image content and delivering the moving image content with the text data.

Further object of the present invention is to provide a computer-readable recording medium recording streaming delivery program for superimposing text data associated with a moving image content to be streamed on the moving image content and delivering the moving image content with the text data.

A streaming delivery method of the present invention includes collecting text data relating to a moving image content being streamed by a streaming server, the text data being written from a user terminal, superimposing the collected text data on the moving image content being streamed by the streaming server, and delivering the moving image content on which the text data is superimposed to the user terminal by the streaming server.

A streaming delivery system of the present invention includes a user terminal, a Web server having a text entry area in which text data relating to a moving image content being streamed is written from the user terminal, and a streaming server collecting the text data, superimposing the collected text data on the moving image content being streamed, and delivering the moving image content on which a plurality of the text data is superimposed to the user terminal.

A streaming server of the present invention includes means for collecting text data relating to a moving image content being streamed, the text data being written from a user terminal, means for superimposing the collected text data on the moving image content being streamed, and means for delivering the moving image content on which the text data is superimposed to the user terminal.

A streaming delivery program for streaming a moving image content of the present invention causes a computer to execute collecting text data relating to a moving image content being streamed, the text data being written from a user terminal, superimposing the collected text data on the moving image content being streamed, and delivering the moving image content on which the text data is superimposed to the user terminal.

A computer-readable program recording medium of the present invention records the above described streaming delivery program for streaming a moving image content.

According to the streaming delivery method and system and streaming server of the present invention, user-input text data on a bulletin board is superimposed on a content delivered or broadcast and is streamed. Accordingly, a user can see the content delivered or broadcast and the text data (text) written about the content on a Web bulletin board or chat room on the same screen at a time. This is considerably convenient for the user. The user can enjoy the event as when he or she was in the venue. As a result, the number of viewers of streaming contents will be probably increased. Furthermore, the content provider or broadcaster can obtain feedback from viewers in real time and therefore can stream an audience participation program such as an auction and questionnaire.

According to the streaming delivery program and the computer-readable recording medium thereof of the present invention, the above described streaming delivery method and system and streaming server are realized and also the program is provided in forms stored in various recording medium.

### BRIEF DESCRIPTION OF THE DRAWINGS

FIG. 1 is a diagram showing a structure of a streaming delivery system.

FIG. 2 is a diagram illustrating a streaming delivery process, and more particularly FIGS. 2A to 2D shows examples of lists, units or databases which are used in a streaming delivery process.

FIG. 3 is a diagram illustrating a streaming delivery process.

FIG. 4 is a diagram illustrating a streaming delivery process.

FIG. 5 is a diagram illustrating a streaming delivery process.

FIG. 6 is a diagram illustrating a streaming delivery process.

FIG. 7 is a flowchart of a streaming delivery process.

FIG. 8 is a flowchart of a display list generating process.

FIG. 9 is a diagram showing a structure of an alternative streaming delivery system.

FIG. 10 is a diagram illustrating an alternative streaming delivery process.

### DETAILED DESCRIPTION OF THE PREFERRED EMBODIMENTS

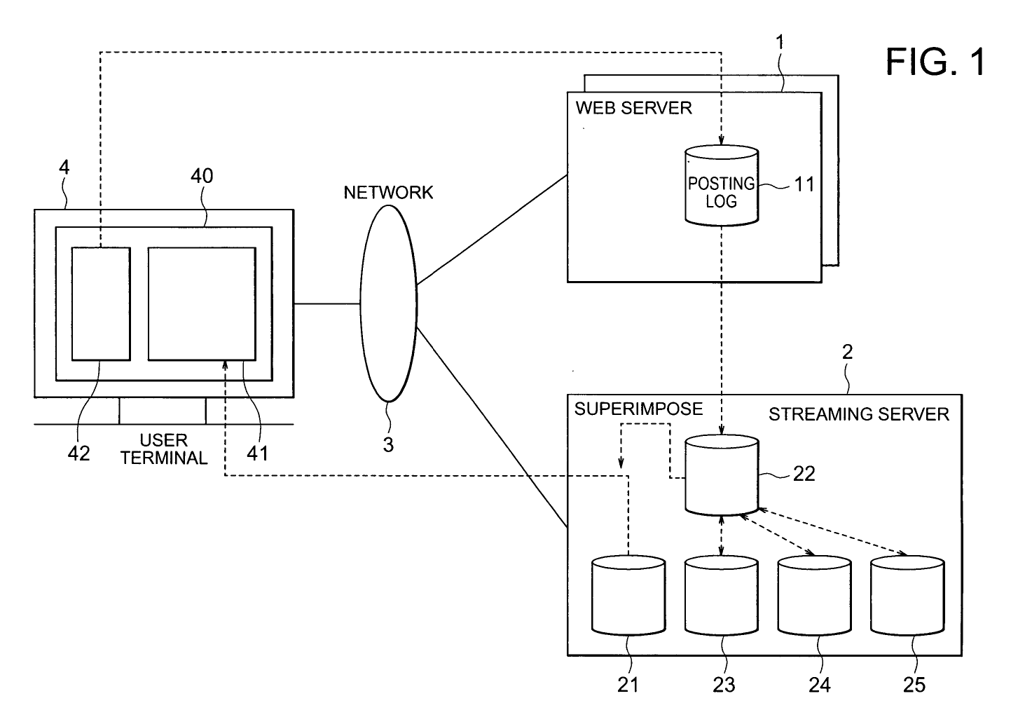

FIG. 1 is a diagram showing a structure of a streaming delivery system that implements a streaming delivery method according to the present invention.

The streaming delivery system includes a Web server 1, a streaming server 2 and a user terminal (client computer) 4. Two windows 41 and 42, for example, are opened on a single screen 40 of a single user terminal 4. The Web server 1 and the streaming server 2 are interconnected through a network 3 and communicate with each other. The streaming server 2 and the user terminal 4 are interconnected through the network 3 which is capable of streaming a moving image data and the former streams a moving image on which text data is superimposed to the latter. The moving image is displayed in the window 41. The user terminal 4 and the Web server 1 are interconnected through the network 3 and communicate with each other. In particular, a user of the user terminal 4 writes a message composed of text data (character data) on a Web bulletin board (42), for example, provided by the Web server 1. The Web bulletin board is displayed in the window 42 (hereinafter also referred to as the Web bulletin board 42). One or more user terminals 4 may be provided.

The streaming server 2 includes a content file 21 storing moving image contents and streams a moving image content read from the content file 21 to one or more user terminals 4 through the network 3. The content file 21 is a well-known file storing a moving image. In this example, streaming delivery is performed by using the well-known SMIL (Synchronized Multimedia Integrated Language). This allows the streaming server 2 to synchronize a moving image content and text data, both to be streamed, into a single content and deliver (send or transfer) the single content, thereby causing the video and text to be displayed on the same window 41 at a time.

Each user terminal 4 receives a moving image content from the streaming server 2 and displays the moving image on the window 41 of its screen 40. A user watching the moving image content writes (enters) a message composed of text data in a text entry area 42 such as a Web bulletin board 42 (hereinafter also referred to as the text entry area 42) provided by the Web server 1 on the same screen 40 from the user terminal 4.

The Web server 1 provides a text entry area 42 to the user terminal 4 through the network 3. The text entry area 42 is a Web bulletin board 42 or a chat posting area 42 associated with a moving image content being streamed. The text entry area 42 is associated with the moving image content being streamed by the Web server 1 in advance. One or more text data relating to a moving image content being streamed are written in the text entry area 42 by the user terminal 4. The text data is a message written (entered) in a Web bulletin board 42 from a user terminal 4 or a message written (entered) in a chat from a user terminal 4. The message is words of cheer for players when the moving image content is a sport game, for example. The text data may be collected from a text entry area 42 other than a Web bulletin board 42 and chat posting area 42.

The Web server 1 has a posting log file 11. The Web server 1 constantly collects text data entered in the text entry area 42 from the user terminal 4 and stores the collected text data in posting log file 11 in the order in which the data is collected.

The streaming server 2 collects text data stored in the posting log file 11 of the Web server 1. Accordingly, the text data collected by the streaming server 2 is text data that relates to a moving image content being streamed and is written in the text entry area 42 associated with that moving image content from one or more user terminals 4. One or more text data are collected. More than one Web server 1 may be provided.

The streaming server 2 periodically collects from the Web server 1 the text data written by the user terminal 4. The interval is a log collection interval set in a log collection interval setting unit 223, which will be described later, and it is set in an initialization process. The interval may be approximately 1 to 2 seconds, for example.

The streaming server 2 superimposes the collected text data on a moving image data being streamed and delivers the moving image content with the text data to the user terminals 4. For this purpose, the streaming server 2 collects text data written in the posting log file 11 of the Web server 1 and temporarily stores the text data in a posting list 221 in a temporary data storage 22. After collecting the text data, the streaming server 2 counts the number of text data stored in the posting list 221 during the collection and stores the count value in a posting count setting unit 225, which will be described later.

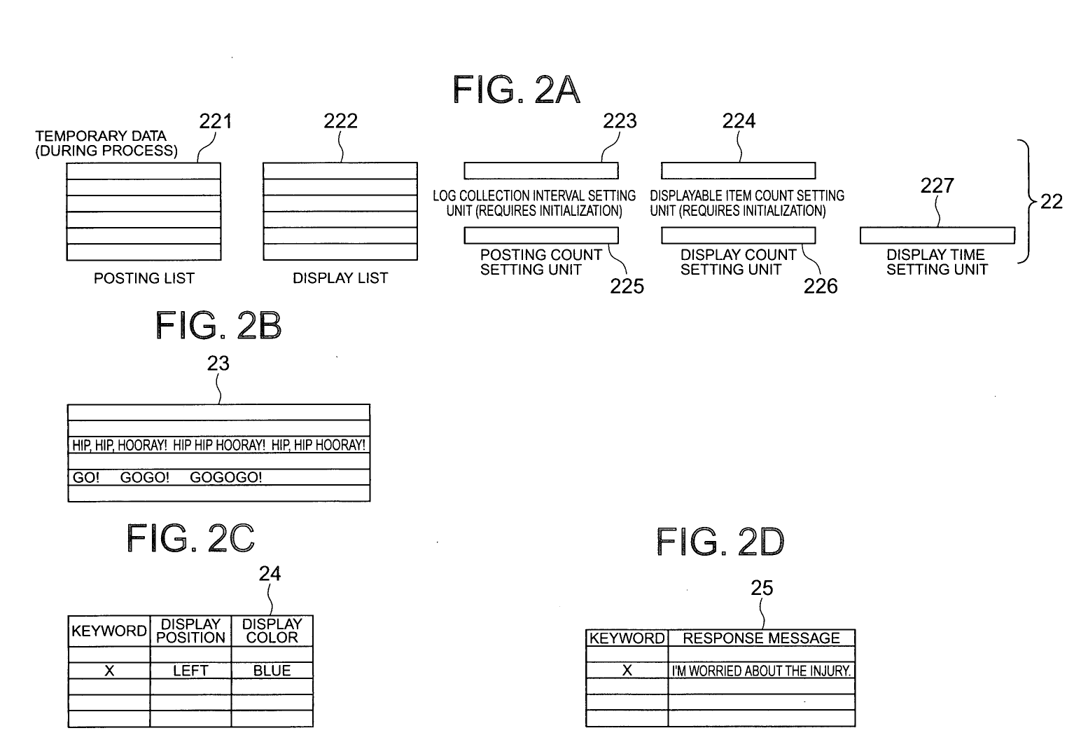

The streaming server 2 has the temporary data storage 22. FIG. 2A shows an example of the temporary data storage 22. The temporary data storage 22 includes a posting list 221, a display list 222, a log collection interval setting unit 223, a setting unit in which count of items (or text data, hereinafter the same) which are displayable on a screen at once is set (hereinafter referred to as a displayable item count setting unit) 224, a posting count setting unit 225, a display count setting unit 226, and a display time setting unit 227, as shown in FIG. 2A.

The posting list 221 stores the text data collected by the streaming server 2 from the posting log file 11 of the Web server 1. The display list 222 stores candidate of the text data intended to be superimposed on a moving image content being streamed and delivered to user terminals 4 (text data to be superimposed but not yet superimposed). The log collection interval setting unit 223 stores a log collection interval value. The log collection interval specifies the interval at which text data written from user terminals 4 is collected from the Web server 1, and is preset by input from external of the system in the initialization process. The posting list 221 and the display list 222 are effective during the log collection intervals. Text data in the same list 221 and the same list 222 is text data collected at a time (with the same timing) and is displayed at a time (with the same timing). The posting list 221 and the display list 222 are updated at each of the log collection intervals.

The displayable item count setting unit 224 stores the number of items which can be displayed on a screen at a time (hereinafter referred to as a displayable item count). The displayable item count specifies the number of text data which can be displayed in a window 41 at a time. The displayable item count is preset by input from external of the system in initialization process. The displayable item count is set with consideration given to the typical size of the window 41. The posting count setting unit 225 stores the number of posts. The number of posts represents the number of text data stored in the posting list 221. The display count setting unit 226 stores the number of displayed items. The number of displayed items represents the number of text data stored in the display list 222, namely, the number of candidate of the text data intended to be superimposed on a moving image content being streamed and to be delivered to user terminals 4. The display time setting unit 227 stores a display time value. The display time represents the time in which the superimposed text data is displayed. The display time is determined on the basis of the number of text data collected (posting count) and the number of text data which can be displayed in the window 41 at a time (display item count).

In this example, when the collected text data (text data in the posting list 221) includes a data which are similar (or the identical, the same applies where appropriate hereinafter) to each other, the streaming server 2 superimposes only one of a plurality of the text data on a moving image content being streamed. This can reduce the number of text data to be superimposed and displayed (by excluding similar text data) to make the superimposed text data easily visible to users. In other words, this can prevent the streamed image from becoming cluttered or prevent the display time of the text data from becoming extremely short. For example, when a large number of text data are posted during an exciting sport game, the text data can be sorted out and a reduced number of text data can be superimposed.

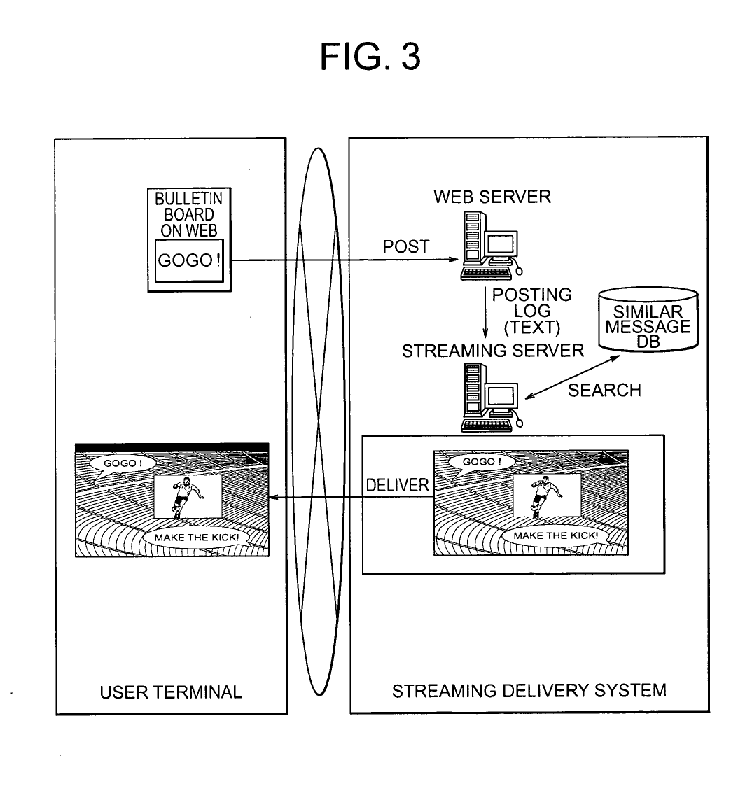

In particular, when collected text data (text data in the posting list 221) includes a text data similar to any of text data which are provided beforehand (similar text data) as shown in FIG. 3, the streaming server 2 does not superimpose the text data similar to the similar text data on the moving image data being streamed. For this purpose, a similar message database (DB) 23 for storing similar text data (similar messages) is provided in the streaming server 2. The streaming server 2 compares a plurality of the text data in the posting list 221 with a plurality of the text data in the similar message DB 23 to determine whether there is a match. An example of the similar message DB 23 is shown in FIG. 2B. The similar text data is a text data which appear frequently and comprises one or plurality of text data which are similar to each other and are stored in the same record.

For example, text data which frequently appears during a sport game is “GO!” Therefore, as a similar text data, “GO!”, “GO, GO!”, and “GO, GO, GO!”, for example are stored in a single record. When a text data in the posting list 221 is “GO!”, then this text data “GO!” is not superimposed, because the same text data is contained in the similar message DB 23. Consequently, the streaming server 2 does not store (or discard) this text data “GO!” in the display list 222. When, however, the display list 222 does not contain the text data “GO!”, this text data “GO!” in the posting list 221 is superimposed. Therefore the streaming server 2 stores this text data “GO!” in the display list 222.

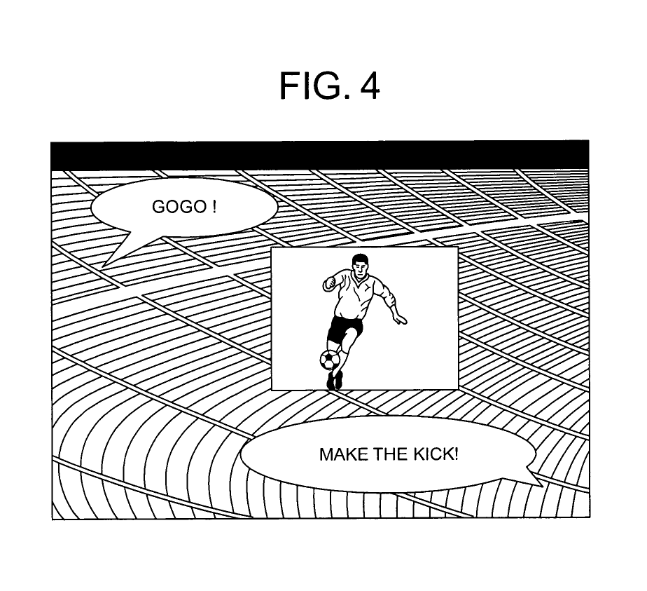

Furthermore, when a text data in the posting list 221 is “GO, GO, GO!”, this text data “GO, GO, GO!” is not superimposed (is not stored in the display list 222 and discarded) because a similar text data “GO, GO!” is contained in the similar message DB 23. When, however, the display list 222 does not contain the text data “GO, GO, GO!”, this text data “GO, GO, GO!” in the posting list 221 is superimposed (stored in the display list 222). Similar messages are dealt with in this way and a screen is provided on a user terminal 4 as shown in FIG. 4, in which text data such as “GO, GO!” and “Make the kick!” are superimposed on a moving image of a soccer game which is being streamed.

When collected text data (text data in posting list 221) includes text data similar to candidate of text data intended to be superimposed on a moving image content being streamed (text data in the display list 222), the streaming server 2 does not superimpose the text data similar to the candidate of text data on the moving image content being streamed (instead, it discards the text data). For this purpose, the streaming server 2 compares a plurality of the text data in the posting list 221 and a plurality of the text data in the display list 222 to determine whether there is a match.

For example, when a text data in the posting list 221 is “GO!” and the same text data is contained in the display list 222, this text data “GO!” is not superimposed (is not stored in the display list 222). Furthermore, when a text data in the posting list 221 is “GO, GO, GO!”, for example, and the text data “GO, GO!” is contained in the display list 222, this text data “GO, GO, GO!” is not superimposed (is not stored in the display list 222).

The streaming server 2 sets display time per text data on the basis of the number of text data collected (text data in the posting list 221) and the number of text data which can be displayed in the window 41 at a time. For this purpose, the streaming server 2 compares the posting count in the posting count setting unit 225 with the displayable item count in the displayable item count setting unit 224. When the posting count is smaller than the displayable item count, the text data in the posting list 221 can be displayed in the same window 41 at the same time (one time). Accordingly, in this case, the display time per text data (a time period in which one text data is being superimposed) is equal to the log collection interval. In other words, the display time is the period from the time the collected text data is displayed to the time new text data collected in the next log collection interval is displayed. This means displaying text data in the same window 41 at a time.

When the posting count is greater than the displayable item count, the text data in the posting list 221 cannot be displayed in the same window 41 at a time. Therefore, the display time must be adjusted as a function of the number of text data collected. In particular, when the posting count (the number of text data collected) is larger than the displayable item count (the number of text data which can be displayed in the window 41 at a time), the streaming server 2 sets the display time to a smaller value as the posting count increases. For example, when the posting count is 10, the displayable item count is 5, and the log collection interval is 2 seconds, then the display time is set to one second. That is, (posting count)/(displayable item count) is rounded up to an integer and the log collection interval is divided by the integer to obtain the display time. In this way, the superimposed text data can be made easily visible to the users and the collected text data can be displayed until the next log collection interval.

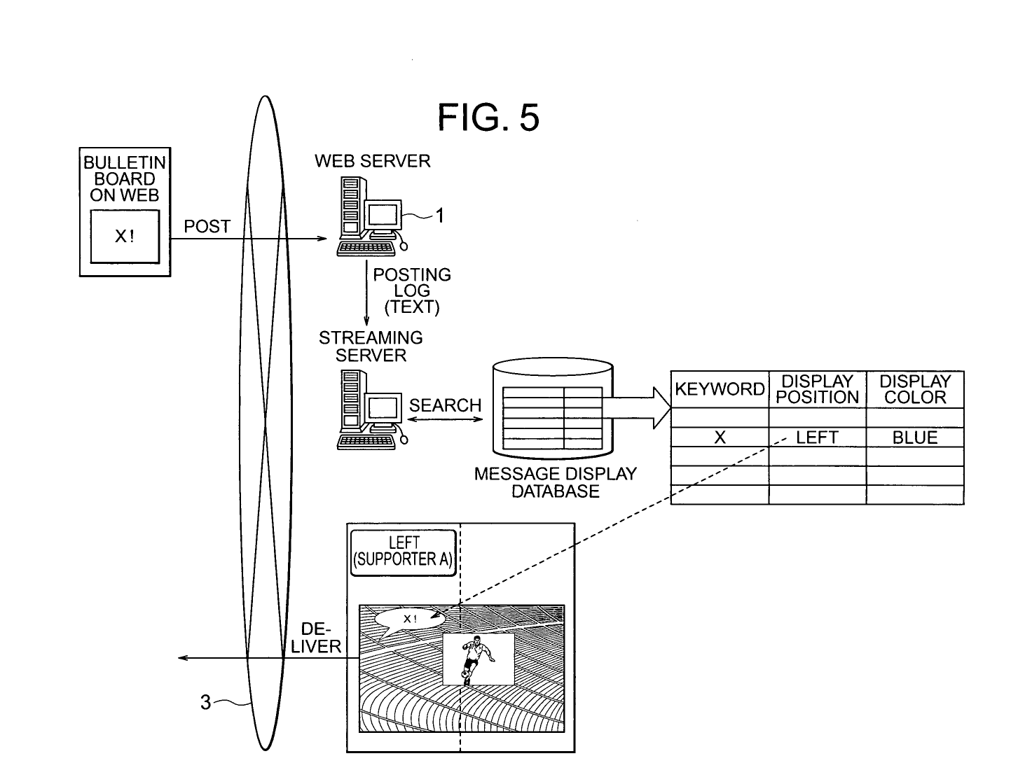

As shown in FIG. 5, the streaming server 2 sets the display position or color (background color or font color) in the window 41 of at least one of the collected text data (text data in the display list 222) according to the meaning of the text data. The display position or color in the window 41 is predetermined for each text data. For this purpose, a message display database (DB) 24 is provided in the streaming server 2. FIG. 2C shows an example of the message display DB 24. The message display DB 24 stores an approximate display position and color with each of the keywords, using proper nouns which are likely to frequently appear or are of keen interest to viewers as keywords.

For example, when the moving image content is a soccer game, the names of players are used as the keywords. When a team to which player X belongs appears in the left-hand part of the window 41, the display position of the keyword or text data is set as “left.” Accordingly, cheering messages for the same team appears near to one another in the window 41. Thus, the superimposed text data is easily visible to viewers. When the team color (uniform color) of the team to which player X belongs is blue, the display color of the keyword or text data (background color or font color in the box in which the text data is displayed) is set as “blue.” When the name of the player (text data) is contained in the display list 222, the text data superimposed on the moving image content is displayed in the position or color set in message display DB 24.

One or both of the display position or color in the window 41 may be set in message display DB 24. Furthermore, when the teams change sides (or court) at the first half break as in a soccer game, the display position may be changed accordingly.

When no display position is specified, text data is superimposed and displayed in a predetermined position in the window 41. The display positions are preset in same number with the number of the displayable item. When the display color of text data is not specified, text data is displayed against the same background color as that of the window 41 in a normal (black, for example) font.

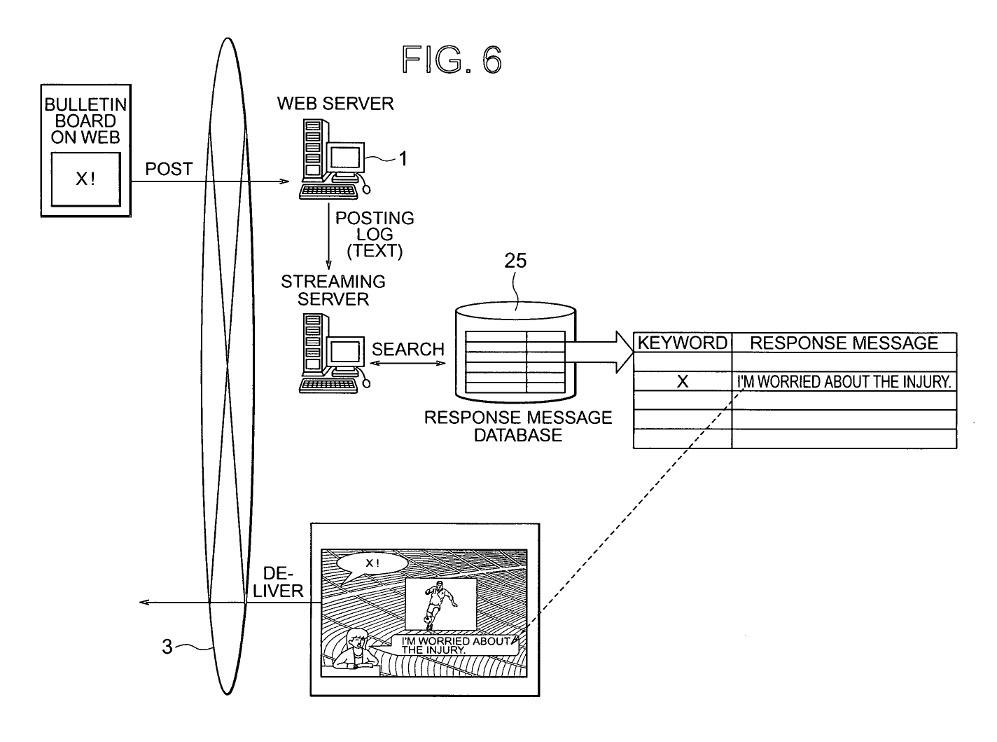

As shown in FIG. 6, for at least one of collected text data (a plurality of the text data in the display list 222), the streaming server 2 superimposes a new text data (message), which relates to but different from the text data, at the same time according to the meaning of the text data. The new text data is predetermined for each text data. For this purpose, a response message database (DB) 25 is provided in the streaming server 2. An example of the response message DB 25 is shown in FIG. 2D. The response message DB 25 stores a new text data to be superimposed at the same time with each keyword, using proper nouns which are likely to frequently appear or are of keen interest to viewers as keywords.

For example, when the moving image content is soccer game, the name of a player is used as the keyword. When player X is injured, text data (response message) saying “I'm worried about the injury.” for example is stored in the response message DB 25. Response messages is commentary by a commentator in live broadcasting of the content, a brief personal history of player X, and the physical condition of player X on the day, for example. The response message can provide information relating to the text data (such as commentary) to viewers. When the name of a player (text data) are contained in the display list 222 and the name is superimposed on a moving image content, a new text data in the response message DB 25 is superimposed and displayed at the same time.

A plurality of response message may be associated with one keyword and stored in the response message DB 25. In this case, one of different response messages can be randomly selected and displayed.

The streaming server as described above is implemented by executing a streaming delivery program of the present invention on the CPU of the server. The streaming delivery program of the present invention can be provided as a program recorded on a program recording medium such as a flexible disk, CD-ROM, CDR/W, and DVD. Alternatively, it can be provided as a program downloadable through a network 3. This allows the streaming delivery system of the present invention to be readily implemented.

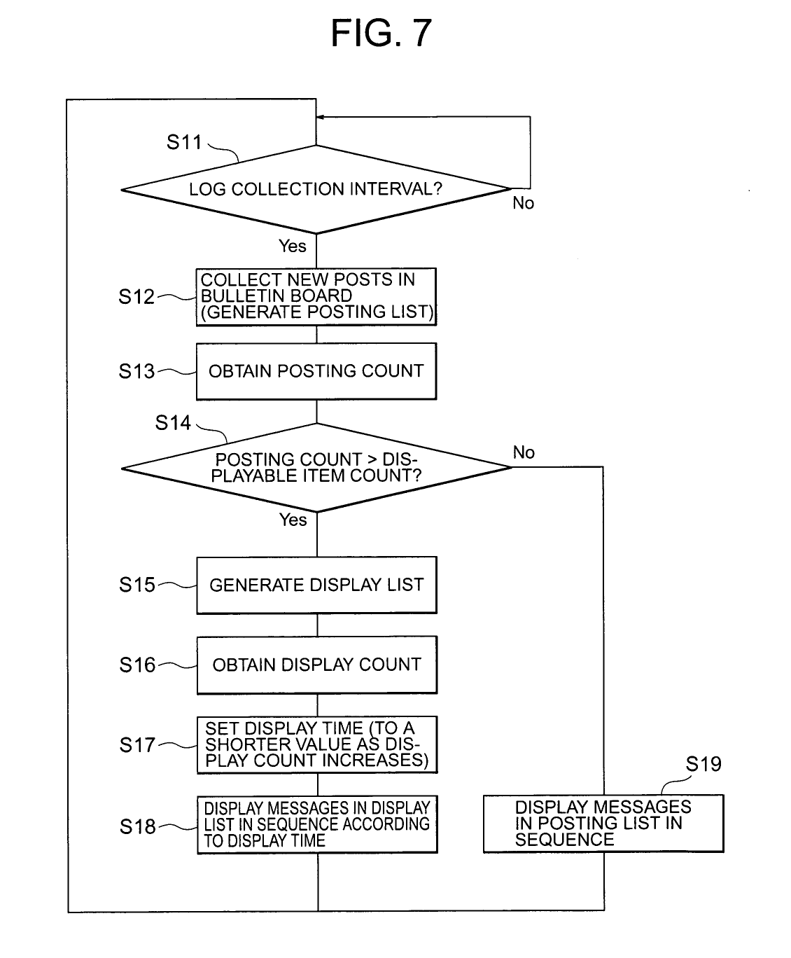

FIG. 7 is a flowchart of a streaming delivery process in which a moving image content on which text data is superimposed is streamed in a streaming delivery system of the present invention.

Before starting the moving image delivery process, a system administrator initializes the system. In particular, the system administrator sets a log collection interval in a log collection interval setting unit 223 and sets the number of items which can be displayed on a screen at a time in a displayable item count setting unit 224 through an input device such as a keyboard (not shown) of a streaming server 2.

When a process for delivering a moving image content is started, the streaming server 2 streams the moving image content to user terminals 4. At this process, the streaming server 2 uses SMIL or the like to synchronize the moving image content (for example, live image broadcasting of a sport game) and text data in a Web bulletin board 42 into a single content and delivers the content. This allows a user terminal 4 to display the image of the moving image content and the text data in same window 41 at a time. A user watching the moving image content writes messages (text data) such as cheering words or impressions on the Web bulletin board 42 on a Web server 1 from the user terminal 4 at any time.

The streaming server 2 determines whether or not the log collection interval set in the log collection interval setting unit 223 has elapsed (step S11) and, if not, repeats step S11. When the log collection interval has elapsed, the streaming server 2 collects the text data newly posted on the Web bulletin board 42 from a posting log file 11 of the Web server 1 and stores the collected text data in a posting list 221. Thus, the streaming server 2 generates the posting list 221 of that collection interval (step S12). The streaming server 2 then counts the number of text data stored in the posting list 221 to obtain the posting count and stores it in a posting count setting unit 225 (step S13).

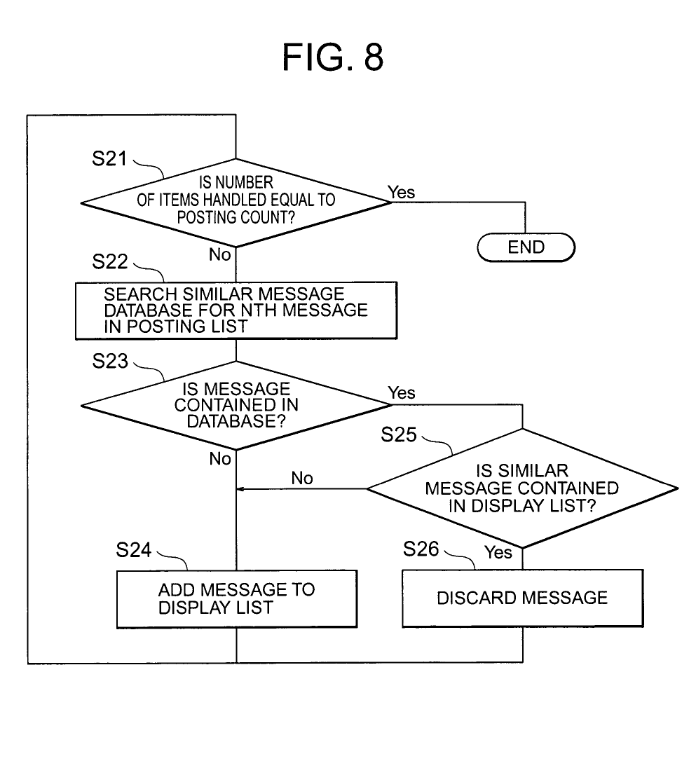

The streaming server 2 determines whether or not the posting count is greater than the displayable item count set in the displayable item count setting unit 224 (step S14). When the posting count is greater than the displayable item count, the streaming server 2 sorts out the text data as described earlier and generates a display list 222 (step S15), which will be described later with reference to FIG. 8. The streaming server 2 then counts the number of text data stored in the display list 222 to obtain the display count, that is, stores it in a display count setting unit 226 (step S16). The streaming server 2 sets display time on the basis of the display count, that is, stores it in a display time setting unit 227 (step S17). The greater the display count, the shorter the display time set, as described earlier.

Then, the streaming server 2 reads messages contained in the display list 222 in sequence from the first stored one, superimposes them on the moving image content according to the display time by using SMIL, and delivers the moving image content to a user terminal 4 to cause the moving image content to be displayed in a window 41 (step S18), then repeats step S11 and the subsequent steps. When the posting count is not greater than the displayable item count at step S14, the streaming server 2 reads the messages contained in the posting list 221, generated at step S12, in sequence from the first stored one, superimposes them on the moving image content according to the display time, and delivers the moving image content to the user terminal 4 to cause the moving image content to be displayed in the window 41 (step S19), then repeats step S11 and the subsequent steps.

FIG. 8 is a flowchart of a display list generating process in which the display list 222 is generated in the streaming delivery system of the present invention.

In step S15 in FIG. 7, a determination is made as to whether or not as many of text data in the posting list 221 generated at step S12 as the posting count have been handled (step S21). When handled, the streaming server 2 ends the display list generating step. If not, the streaming server 2 adds “1” to a value “n” (where n is a positive integer and its initial value is 0) and then uses the nth message in the posting list 221 as a key to search a similar message DB 23 (step S22) to determine whether or not that message is contained in the similar message DB 23 (step S23). When the message is not contained in the similar message DB 23, the streaming server adds the message to the display list 222 (step S24) and repeats the step S21 and the subsequent steps. On the other hand, when the message is contained in the similar message DB 23 at step S23, the streaming server 2 determines whether or not the message is contained in the display list 222 (step S25). When the message is not contained in the display list 222, the streaming server 2 performs step S24. When the message is contained in the display list 222 at step S25, the streaming server 2 discards the message (step S26) and repeats the step S21 and the subsequent steps.

The present invention has been described with respect to an embodiment thereof. However, various variations of the present invention are possible without departing from the spirit and scope of the present invention.

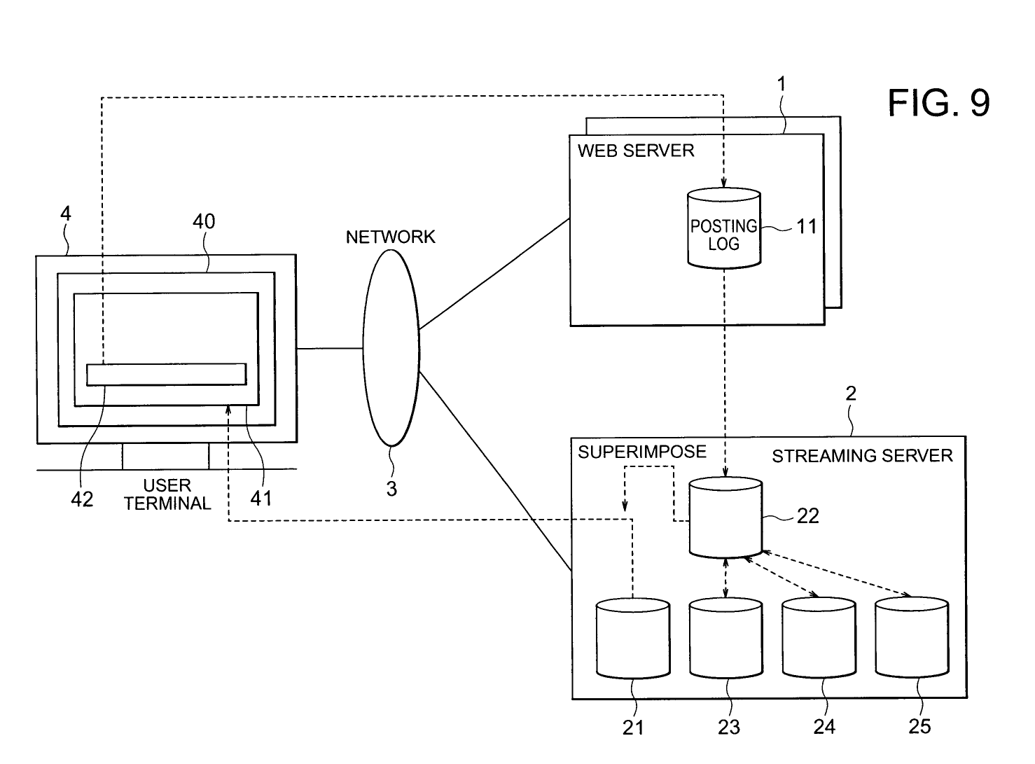

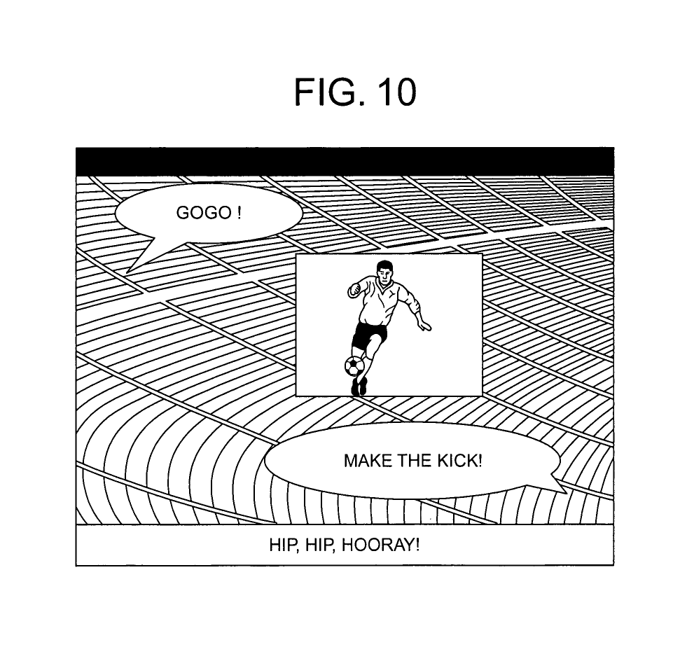

For example, as shown in FIG. 9, the streaming server 2 may display a text entry area 42 which is associated with a moving image content being streamed to be displayed in a window 41 in which the moving image content is displayed. That is, as shown in FIG. 10, a text entry area 42 is provided within a window 41 in which a moving image content being streamed is played. For this purpose, a streaming server embeds an SMIL content and CGI the text entry area 42 into a single HTML page. Different URLs are assigned to the SMIL content and the CGI the text entry area 42. This allows a user to read messages in a Web bulletin board 42 and post a message on the spot while watching a moving image content being streamed, simply all in a single window 41.

As has been described, the present invention provides a streaming delivery method, apparatus and system in which text data on a Web bulletin board entered by a user is superimposed on a content being delivered or broadcast and streamed with the content. Therefore, a user can at least see, along with a content being delivered or broadcast, the text data written on a Web bulletin board or a chat room about the content on the same screen at the same time. Thus, the user can enjoy an event as when he or she was in the venue of the event. Furthermore, a streaming content provider or broadcaster can expect an increased number of viewers of streaming contents and obtain feedback from viewers in real time and therefore can stream an audience participation program such as an auction and questionnaire.

Also, the present invention provides a streaming delivery program and a computer-readable recording medium thereof the above described streaming delivery method and system and streaming server are realized and also the program is provided in forms stored in various recording medium.

What is claimed is:

1. A streaming delivery method comprising:
collecting text data relating to a moving image content being streamed by a streaming server, the text data being written from a user terminal;
superimposing the collected text data on the moving image content being streamed by the streaming server; and
delivering the moving image content on which the text data is superimposed to the user terminal by the streaming server.

2. A streaming delivery method according to claim 1, wherein the text data are written from the user terminal into a text entry area associated with the moving image content being streamed.

3. A streaming delivery method according to claim 2, wherein the text entry area is a Web bulletin board or a chat area associated with the moving image content being streamed.

4. A streaming delivery method according to claim 1, wherein the streaming server periodically collects text data written from the user terminal.

5. A streaming delivery method according to claim 1, wherein, in a case that a plurality of the text data is collected and the collected text data include text data similar to one another, the streaming server superimposes only one of the plurality of the text data on the moving image content being streamed.

6. A streaming delivery method according to claim 5, wherein, in a case that a plurality of the text data is collected and the collected text data include text data similar to text data provided beforehand, the streaming server does not superimposes the text data similar to the provided text data on the moving image content being streamed.

7. A streaming delivery method according to claim 5, wherein, in a case that the collected text data include text data similar to candidate of text data intended to be superimposed on the moving image content being streamed, the streaming server does not superimpose the text data similar to the candidate of text data intended on the moving image content being streamed.

8. A streaming delivery method according to claim 1, wherein the streaming server sets display time per the collected text data on a basis of the number of the collected text data and the number of text data which can be displayed on a screen at a time.

9. A streaming delivery method according to claim 8, wherein, in a case that the number of collected text data is greater than the number of text data which can be displayed on the screen at a time, the streaming server sets the display time to a shorter value as the number of the collected text data increases.

10. A streaming delivery method according to claim 1, wherein the streaming server sets the display position or color of at least one of the collected text data on the screen according to the meaning of the text data.

11. A streaming delivery method according to claim 10, wherein the display position or color on the screen is predetermined for each of the text data.

12. A streaming delivery method according to claim 1, wherein the streaming server superimposes a new text data along with at least one of the collected text data at the same time according to the meaning of one of the collected text data, the meaning of the new text data being different from one of the collected text data.

13. A streaming delivery method according to claim 12, wherein the new text data is predetermined for each of the text data.

14. A streaming delivery method according to claim 1, wherein the streaming server displays a text entry area associated with the moving image content being streamed in a window in which the moving image content is displayed.

15. A streaming delivery system comprising:
a user terminal;
a Web server having a text entry area in which text data relating to a moving image content being streamed is written from the user terminal; and
a streaming server collecting the text data, superimposing the collected text data on the moving image content being streamed, and delivering the moving image content on which the text data is superimposed to the user terminal.

16. A streaming server comprising:
means for collecting text data relating to a moving image content being streamed, the text data being written from a user terminal;
means for superimposing the collected text data on the moving image content being streamed; and
means for delivering the moving image content on which the text data is superimposed to the user terminal.

17. A streaming delivery program for streaming a moving image content, wherein the program causes a computer to execute:
collecting text data relating to a moving image content being streamed, the text data being written from a user terminal;
superimposing the collected text data on the moving image content being streamed; and
delivering the moving image content on which the text data is superimposed to the user terminal.

18. A computer-readable program recording medium recording a streaming delivery program for streaming a moving image content, wherein the program causes a computer to execute:
collecting text data relating to a moving image content being streamed, the text data being written from a user terminal;
superimposing the collected text data on the moving image content being streamed; and
delivering the moving image content on which the text data is superimposed to the user terminal.
